(19) United States
(12) Patent Application Publication
(10) Pub. No.: US 2006/0055271 A1
(43) Pub. Date: Mar. 16, 2006

(54) FLAT MOTOR WITH BRUSHES

(75) Inventor: Ryoji Kaneko, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori=machi (JP)

(21) Appl. No.: 11/162,243

(22) Filed: Sep. 2, 2005

(30) Foreign Application Priority Data
Sep. 13, 2004 (JP) 2004-265063

(51) Int. Cl. H02K 23/04; H02K 3/04; H02K 1/22

(52) U.S. Cl. 310/208; 310/154.06; 310/268

(57) ABSTRACT

A flat electrical machine having high efficiency by configuring the coil windings so that adjacent edges thereof are closely adjacent, extend radially and do not overlap circumferentially. The thickness of the windings varies along their length and thee facing magnets are also tapered to maintain a constant and small air gap. In addition the coli winding ends are connected to commutator segments to maintain at least two air gaps between connected segments at all times to avoid voltage leakage.

### BACKGROUND OF THE INVENTION

This invention relates to an electric motor and more particularly to a flat, brush type electric motor having a compact construction and high power output.

A flat motor with brushes includes a rotor and a stator which rotate with respect to each other. Generally the rotor includes a rotary shaft, a plurality of flat coil elements fixed at circumferential positions radially around the rotary shaft. A commutator is also fixed to the rotary shaft and connected to the ends of each flat coil element. The stator includes a plurality of magnets facing and sandwiching the flat coil elements, and brushes in sliding contact with the commutator.

In order to produce high torque with this type of flat motor, the gap between the magnets sandwiching and facing the flat coil elements has to be reduced to minimize the magnetic gap. Thus when using flat coil elements with the same number of turns in the radial direction, thinner flat coil elements are more preferable.

In the case of a flat motor with brushes, adjacent flat coil elements are disposed so as to overlap to some degree with each other as viewed in the direction of the rotary shaft as shown in Japanese Published Application JP-A-Hei 6-217502, so that the respective flat coil elements are continuously energized through the brushes via the commutator.

This could be avoided with the use of a brushless flat motor, since respective flat coil elements do not have to be disposed so as to overlap with each other, because their rotational positions are detected by a sensor to control energization. However in some instances this is a rather more expensive machine.

In the conventional flat motor with brushes, however, the flat coil elements must be disposed so as to overlap with each other as noted above. This requires an increased gap between the magnets to clear the overlapping parts of the flat coil elements. Therefore, the magnetic gap is increased, which reduces the effective magnetic flux, and accordingly the amount of torque produced.

It is, therefore, a principal object of the invention to provide a high output flat electrical motor of the brush type.

### SUMMARY OF THE INVENTION

A first feature of this invention is adapted to be embodied in an electric machine and more particularly to a flat, brush type electric machine having a compact construction. The machine comprising a plurality of flat coil elements disposed between a plurality of facing, circumferentially spaced permanent magnets. The coil elements having generally trapezoidal or pie shape with the adjacent edges thereof closely spaced without overlapping each other. A commutator fixed relative to the coils and has segments to which respective coil winding ends are electrically connected. Brushes are in sliding contact with the segments for transferring electrical energy with the coils upon relative rotation between the coils and the permanent magnets.

Another feature of the invention is adapted too be embodied in a machine as set forth in the preceding paragraph and wherein the axial thickness of the coil elements is generally tapered in a radial direction and the adjacent faces of the permanent magnets are tapered in a like manner to maintain a like gap between the coils and the permanent magnets in a radial direction.

Another feature of the invention is adapted to be embodied in an electrical machine as described in the first paragraph of this section wherein the coil windings are connected to the commutator segments in such a way so that there are always two air gaps between connected segments at all times during relative rotation to avoid voltage loss.

### BRIEF DESCRIPTION OF THE DRAWINGS

FIG. 1 is a side elevational view of an electric motor constructed in accordance with an embodiment of the invention and showing the various elements in outline.

FIG. 2 is a cross sectional view taken along the line 2-2 in FIG. 1.

FIG. 3 is a side elevational view showing the shape of a flat coil element employed in the motor.

FIG. 4 is a perspective view of the flat coil element.

FIG. 5 is a sectional views taken along the lines 5-5 of FIG. 4.

FIG. 6 is a sectional view taken along the lines 6-6 of FIG. 4.

FIG. 7 is a perspective view, in part similar to FIG. 4 and shows another embodiment of flat coil element in accordance with the present invention.

FIG. 8 is a developed view showing the connection of coils of the embodiment of FIGS. 1-6.

FIGS. 9A-9C are developed views in part similar to FIG. 8 is a illustrates the connections made during successive stages of rotation during operation of a motor with the connection of coils as shown in FIG. 8.

FIGS. 10A-10C are developed views of coils, in part similar to FIGS. 9A-9C, and show the current flow during successive stages of rotation of another embodiment.

FIGS. 11A-11C are developed views of coils, in part similar to FIGS. 9A-9C and 10A-10C, and show the current flow during successive stages of rotation of yet another embodiment.

FIGS. 12A-12C are developed views of coils, in part similar to FIGS. 9A-9C, 10A-10C and 11A-11C and show the current flow during successive stages of rotation of yet another embodiment.

FIG. 13 is a developed view of another example of coils of the present invention.

FIG. 14 is a developed view of another example of coils of the present invention.

FIG. 15 is a developed view of another example of coils of the present invention.

FIGS. 16A-16C are developed views of coils, in part similar to FIGS. 9A-9C, 10A-10C, 11A-11C and 12A-12C and show the current flow during successive stages of rotation of yet another embodiment.

FIGS. 17A-17C are developed views of coils, in part similar to FIGS. 9A-9C, 10A-10C, 11A-11C, 12A-12C and 16A-16C, and show the current flow during successive stages of rotation of yet another embodiment.

FIG. 18 is a developed view, in part similar to FIG. 10 but showing still another embodiment.

FIG. 19 is a developed view, in part similar to FIG. 15 but showing still another embodiment.

FIGS. 20A-20C are developed views of coils, in part similar to FIGS. 9A-9C, 10A-10C, 11A-11C, 12A-12C, 16A-16C and 17A-17C, and show the current flow during successive stages of rotation of yet another embodiment.

FIGS. 21A-21C are developed views of coils, in part similar to FIGS. 9A-9C, 10A-10C, 11A-11C, 12A-12C, 16A-16C, 17A-17C and 20A-20C and show the current flow during successive stages of rotation of a still further embodiment.

### DETAILED DESCRIPTION

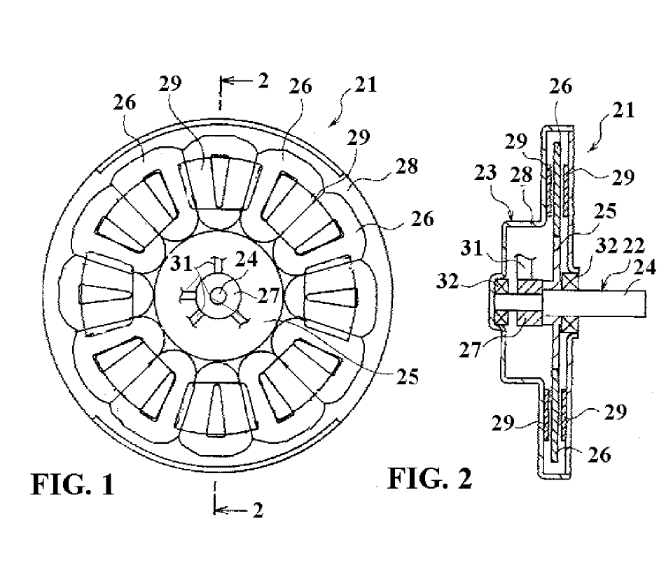

Referring now in detail to the drawings and initially to FIGS. 1 and 2, a flat motor, indicated generally at 21 and constructed in accordance with the invention is comprised of a rotor, indicated generally at 22 and a stator, indicated generally at 23.

The rotor 22 is comprised of a rotary shaft 24 that carries a rotary plate 25. A plurality of (twelve in this embodiment) flat coil elements 26 are secured at radially spaced locations around the outer circumference of the rotary plate 25. Each flat coil element 26 is molded with resin and suitably secured to the outer circumference of the rotary plate 25.

The windings of the coil elements 26 are electrically connected in manners to be described to a commutator 27 fixed to the rotary shaft 24 to rotate together with the rotary plate 25. The outer circumferential surface of the commutator 27 is divided into a plurality of segments 27a corresponding in number to the number of coil elements 26. The respective segments 27a are connected with winding ends of the respective flat coil elements 26, as will be described shortly and as aforenoted.

Continuing to refer to FIGS. 1 and 2, the stator 23 is formed with a motor case 28 for covering the entire motor 21 including the rotor 22. A plurality of pairs of (eight pairs in this example) permanent magnets 29 are fixed to opposing inner surfaces of the motor case 28 in closely spaced facing relation to the flat coil elements 26. A plurality of brushes 31 (four in this embodiment) are carried in sliding contact with the outer circumferential surface of the commutator 27 in any suitable manner. The rotary shaft 24 of the rotor 22 is rotatably supported by the motor case 28 via bearings 32.

As shown in the drawings and particularly FIG. 1, the flat coil elements 26, are of a generally pie shaped pieces arranged radially around the outer circumference of the rotary shaft 24, are configured such that adjacent edges of the coil elements are closely juxtaposed without overlapping with each other. Also as has been noted, the winding ends of each flat coil element 26 are connected to respective segments 27a of the commutator 27 as will be described later.

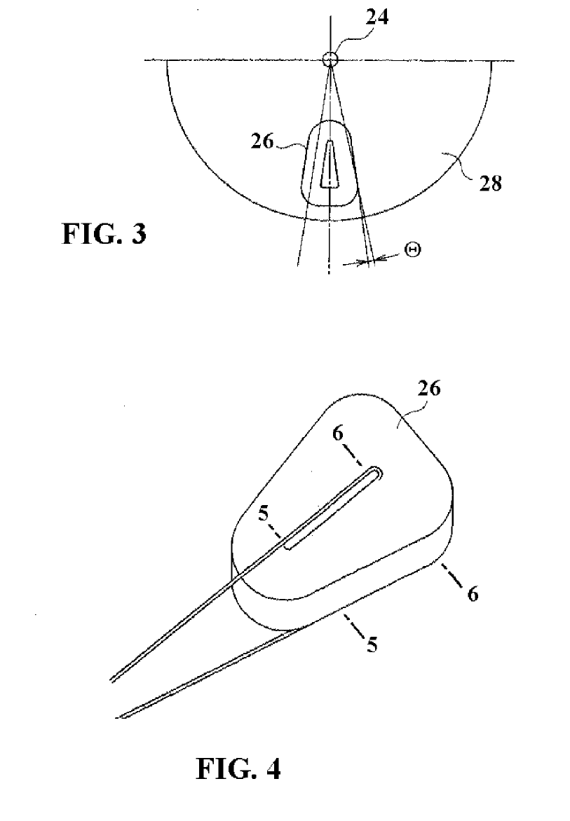

As best seen in FIGS. 3 and 4, each flat coil element 26 is generally formed in the shape of a triangle (or a trapezoid) that is wider on the outer circumferential side thereof. The coil is shaped such that both oblique sides of the flat coil element 26 coincide with radial directions emanating from the rotational axis of the rotary shaft 24. If one oblique side deviates from a radial direction by θ while the other oblique side coincides with a radial direction as shown in this figure, only a component of electric current corresponding to cos θ contributes to torque generation. Thus the electric current applied to the coil element 26 is not effectively utilized. Therefore, it is preferred to shape each flat coil element 26 with sides being disposed so that the angle is reduced to zero and adjacent edges are closely spaced without overlapping each other so that the electric current produces high torque.

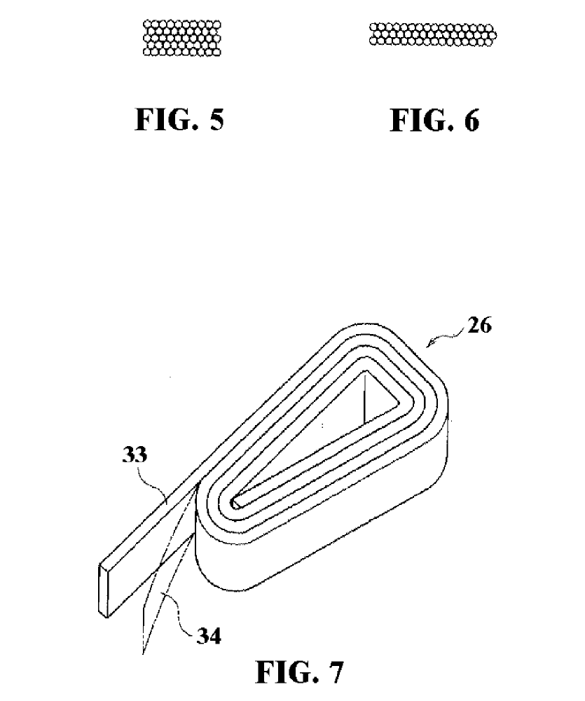

Referring now to FIGS. 5 and 6 it will be seen that the thickness, that is the axial extent, of the flat coil element 26 is greater on the inner circumferential side, shown in FIG. 5, than on the inner circumferential side, shown in FIG. 6. Correspondingly, the gap between the magnets 29 and 29 sandwiching and facing the flat coil elements 26 can be tapered so as to be smaller on the outer circumferential side. The scale of FIG. 2 is, however, so small that this condition can not be illustrated in this view. This can reduce the magnetic gap to produce high torque. It also permits a minimum gap circumferentially between adjacent coils as shown in FIG. 1 without overlapping.

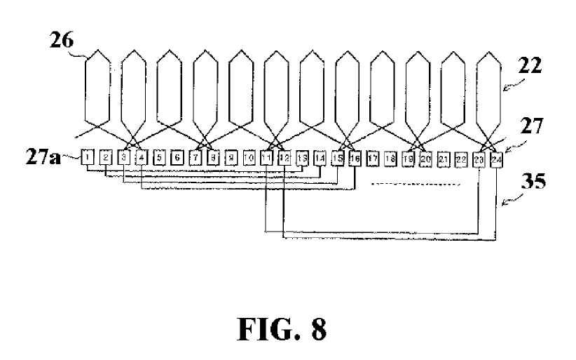

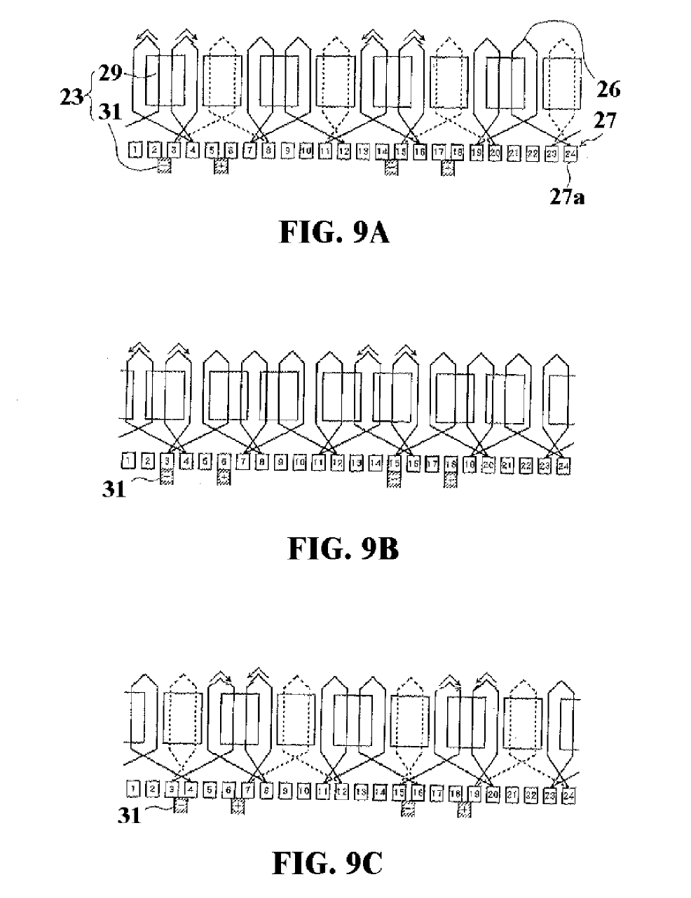

Referring now to FIG. 7, this shows the appearance of a coil according to another embodiment of the present invention. In this embodiment, the flat coil element 26 is formed by winding a band-like iron member 33 generally into the shape of a triangle. An insulating film 34 may be interposed between layers of the winding iron member 33. The surface of the iron member 33 may be copper-plated to increase the electrical conductivity. Instead of using the insulating film 34, the surface of the iron member 33 may be coated with an insulating coating. When the iron member 33 is used as winding, as described, the winding itself also serves as a yoke for forming magnetic fields between the magnets 29 and 29 (see FIGS. 1 and 2). This can further reduce the magnetic gap between the magnets to produce high torque. These coils 26 can be connected as described next by reference to FIGS. 8 and 9A-9C. When the coils with such a connection structure are energized, electric currents which flow through adjacent windings of the coil elements flow in the same direction, which can reduce energy loss and prevent phase shift.

Referring now to FIG. 8, this is a developed view, showing an example of connection of the flat motor shown in FIGS. 1 and 2 and having coil windings as shown in FIGS. 4-6 or FIG. 7. This example of connection is based on the case where the number of magnets 29 “m”=8, the number of coil elements 26 “t”=12, the number of segments 7a of the commutator 27 “s”=24, and the number of brushes 31 “b”=4. The coil elements 26 and the commutator 27 are components of the rotor 22, and the magnets 29 and the brushes 31, which will be described later in more detail by reference to FIGS. 9A-9C, are components of the stator 23.

The winding ends of the respective coil elements 26 are connected to specific of the segments 27a of the commutator 27. Certain of the respective segments 27a are connected with each other by means of wiring 14. The mutual connection between the segments 27a permits a reduction in the number of brushes. The coil elements 26 and the commutator 27 made up of segments 27a are fixed to the rotary shaft 24, as shown in FIGS. 1 and 2, to constitute the rotor 22. The brushes 31 on the stator 23 side successively into contact with the segments 27a, which rotate along with the rotation of the rotor 22, to energize the respective coil elements 26 to drive the motor.

As shown in FIGS. 8 and 9A-9C, both winding ends of each of the twelve coil elements 26 cross each other, cross one winding end of an adjacent coil element, and are connected to the segments 27a. The number of segments “s” is twice the number of coil elements “t,” with two segments 27a provided immediately below each coil element 26. The winding ends of each coil element 26 are connected to either a distant one of the two segments immediately below it, or a distant one of the two segments immediately below an adjacent coil element. The coil elements connected to the segments immediately below themselves and those connected to the segments immediately below adjacent segments are disposed alternately. In other words, every fourth two segments are connected to a coil element and every fourth two other interposed segments are not connected to an coil segment thus forming a series of coils energized in a specific direction, as will be noted. In this way, as shown in the drawing, out of the twenty four segments, twelve segments, namely segments #3, 4, 7, 8, 11, 12, 15, 16, 19, 20, 23, and 24, are used to connect the twelve coil elements 26 to form a series of coils. Such connection can form the series of coils such that adjacent coil elements 26 are energized alternately in opposite directions to each other between positive and negative. This allows electric currents which flow through adjacent windings of the coil elements to flow in the same direction, which can reduce energy loss and prevent phase shift.

The wiring 35 connects the twenty four segments 27a with each other such that each segment 27a is connected to a segment 27a located twelve segments away from it. In other words, the segments #1 and #13, segments #2 and #14, . . . , and segments #12 and #24 are connected. As shown in these figures and as previously described, the respective coil elements 26 are energized through the brushes 31, which are disposed appropriately, to cause the rotor to rotate. The dotted line shows coil elements 26 being switched over and thus not energized.

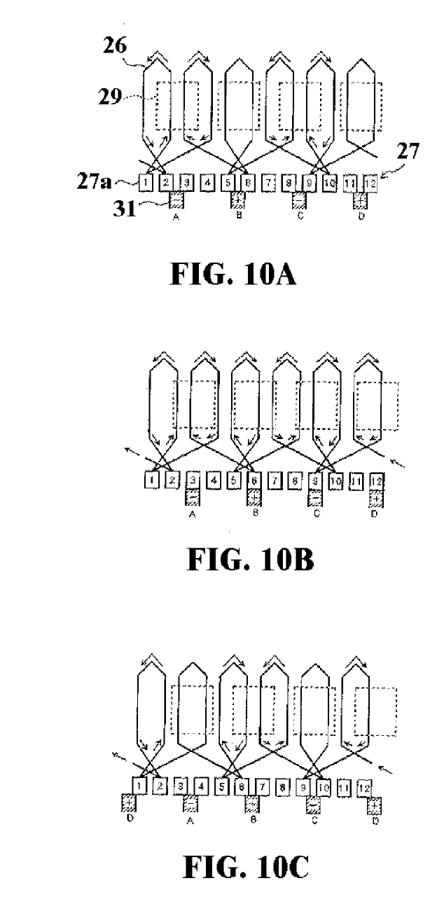

Referring now to FIGS. 10A-10C these views are in part similar to FIGS. 9A-9C and show another embodiment of coil connection structure according to the invention. This embodiment is shown as an example where the number of magnets 29 “m”=4, the number of coil elements 26 “t”=6, the number of segments 27a of the commutator 27 “s”=12, and the number of brushes 31 “b”=4. FIGS. 9A-9C show the states where the brushes 31 sequentially move relatively rightward as seen in the figures by half the segment, along with the rotation of the rotor.

The six flat coil elements 26 are disposed facing the four magnets 29. Both winding ends of each coil element 26 are connected to segments located in predetermined positional relation, out of the twelve segments 27a (#1-#12). As shown in the figures, both winding ends of each coil element 26 cross each other, cross one winding end of an adjacent coil, and are connected to the segments 27a. The number of segments “s” is twice the number of coil elements “t,” with two segments 27a provided immediately below each coil element 26.

The winding ends of a coil element 26 are connected to either a distant one of the two segments immediately below it, or a distant one of the two segments immediately below an adjacent coil element. The coil elements connected to the segments immediately below themselves and those connected to the segments immediately below adjacent segments are disposed alternately. That is, every fourth two segments are connected to a coil element and every fourth two other interposing segments are not connected to a coil segment to form a series of coils. In this way, as shown in the drawing, out of the twelve segments, six segments, namely #1, 2, 5, 6, 9, and 10, are used to connect the six coil elements 26 to form a series of coils. The series of coils are energized through the brushes 31 as indicated by the arrows, which causes adjacent coil elements to be energized in opposite directions to each other between positive and negative, and parallel adjacent windings of the coil elements 26 to be energized in the same direction. This eliminates phase shift.

FIGS. 10A-10C show the states where the brushes 31 sequentially move relatively rightward in the drawing by half the segment, along with the rotation of the rotor. As shown in the drawing, the interval between adjacent brushes 31 is large enough to include two gaps between the segments 27a. Such allowance for two or more gaps between the segments 27a, which serve as an insulating region to improve the insulation performance and the ability to withstand a greater voltage without leakage.

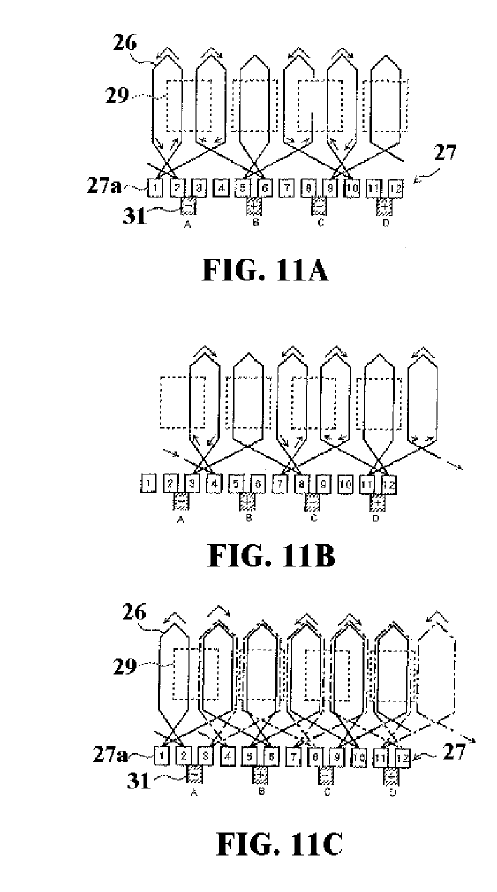

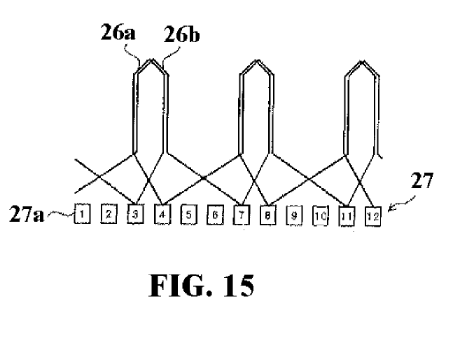

FIGS. 11A-11C illustrate another embodiment of the present invention. In this embodiment, six segments that are not used in the foregoing example of FIGS. 10A-10C (#3, 4, 7, 8, 11, 12) are used to form coil elements 26 of another series of coils, as shown in FIG. 11B, in overlapping relation with the series of FIG. 15A and as shown in FIG. 11C. That is, six segments (#1, 2, 5, 6, 9, and 10) are used in the same manner as in FIGS. 10A-10C to form a series of coils as shown in FIG. 11A, and then the remaining six segments (#3, 4, 7, 8, 11, and 12) are used to form another series of coils over the former series of coils as shown in FIG. 11B. This allows all the segments 27a to be used uniformly as shown in FIG. 11C, which can increase the use efficiency of the segments to produce stable high output. In addition, since the brushes 31 experience substantially constant frictional resistance in association with sliding contact during rotation, deterioration of the brushes can be inhibited to extend the service life of the brushes. Incidentally, in FIG. 11C where the series of coils of FIG. 11A and those of FIG. 11B are overlapped with each other, the circuit of coils of FIG. 11B are indicated by the dot dashed line in FIG. 11C.

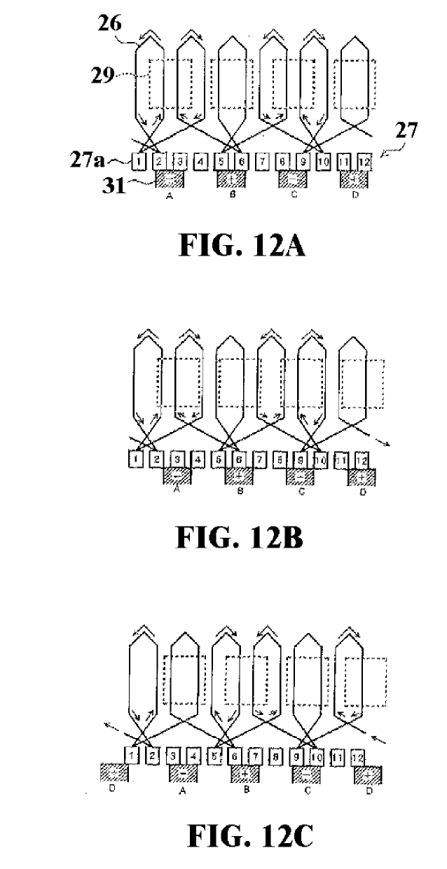

Referring now to FIGS. 12A-12C these views are in part similar to FIGS. 9A-9C and 10A-10C and show another embodiment of coil connection structure according to the invention. In this embodiment shows how the width of the brushes 31 can be increased and hence the gap between the brushes 31 is accordingly reduced. In this embodiment, the interval between the brushes includes only one gap between the segments in the position of FIG. 12B), but includes two gaps between the segments in the positions of FIGS. 12A and 12C. By setting the interval between the brushes 31 so as to include two or more gaps between the segments 27a at at least one position during rotation, the average interval between the brushes is increased to obtain a sufficiently high to prevent voltage leakage. This reduces constraints on the width of the brushes and increases the degree of freedom in design.

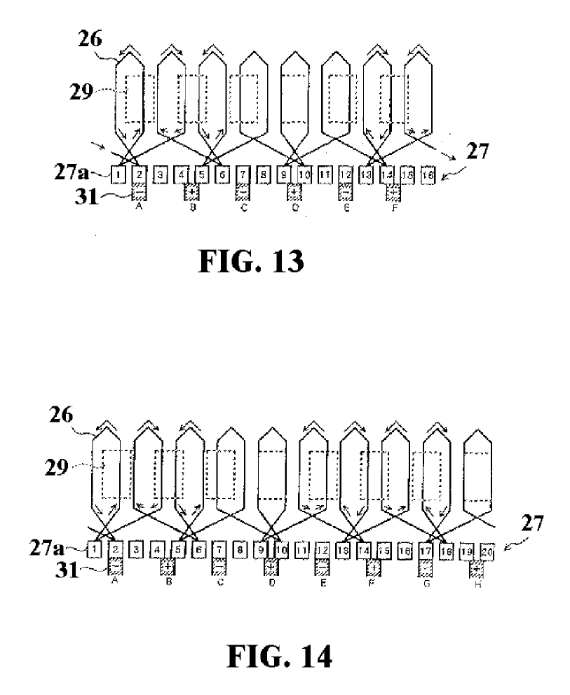

FIG. 13 is a developed view of still another embodiment of the present invention. In this embodiment, the number of magnets “m”=6, the number of coil elements “t”=8, the number of segments “s”=16, and the number of brushes “b”=6. As in the embodiment of FIGS. 10A-10C, 11A-11C and 12A-12C both winding ends of each coil elements 26 cross each other, cross one winding end of an adjacent coil element, and are connected to the segments 27a. The number of segments “s” is twice the number of coil elements “t,” with two segments 27a provided immediately below each coil element 26. The winding ends of each coil element 26 are connected to either a distant one of the two segments immediately below it, or a distant one of the two segments immediately below an adjacent coil element 26.

The coil elements connected to the segments immediately below themselves and those connected to the segments immediately below adjacent segments are disposed alternately. In this way, as shown in the drawing, out of the sixteen segments, eight segments, namely #1, 2, 5, 6, 9, 10, 13, and 14, are used to connect the eight coil elements 26. The series of coils are energized through the brushes 31 as indicated by the arrows, which causes adjacent coil elements to be energized in opposite directions to each other between positive and negative, and parallel adjacent windings of the coil elements 26 to be energized in the same direction. This eliminates phase shift.

In cases where m=6 as described above, as in the foregoing example of FIGS. 11A-11C, the unused segments (#3, 4, 7, 8, 11, 12, 15, and 16) may be used to form another series of coils in overlapping relation.

FIG. 14 is a developed view of still another embodiment of the present invention. In this embodiment, the number of magnets “m”=8, the number of coil elements “t”=10, the number of segments “s”=20, and the number of brushes “b”=8.

As in the foregoing embodiments of FIGS. 10A-10C, 11A-11C, 12A-12C and 13, both winding ends of each coil element 26 cross each other, cross one winding end of an adjacent coil element, and are connected to the segments 27a. The number of segments “s” is twice the number of coil elements “t,” with two segments 27a provided immediately below each coil element 26. The winding ends of each coil element 26 are connected to either a distant one of the two segments immediately below it, or a distant one of the two segments immediately below an adjacent coil element 26. The coil elements connected to the segments immediately below themselves and those connected to the segments immediately below adjacent segments are disposed alternately. In this way, as shown in the drawing, ten segments, namely #1, 2, 5, 6, 9, 10, 13, 14, 17, and 18, are used to connect the ten coil elements 10 to form a series of coils.

The series of coils are energized through the brushes 31 as indicated by the arrows, which causes adjacent coil elements to be energized in opposite directions to each other between positive and negative, and parallel adjacent windings of the coil elements 26 to be energized in the same direction. This eliminates phase shift.

In addition, as in cases where m=8 as described above, as in the foregoing example of FIGS. 11A-11C and 13, the ten unused segments (#3, 4, 7, 8, 11, 12, 15, 16, 19, and 20) may be used to form another series of coils in overlapping relation.

FIG. 15 is a developed view of still another embodiment of the present invention. In this embodiment, three coil elements 26 are provided in a space where six coil elements 26 could be accommodated, with a blank space for one coil element present between respective adjacent coil elements 26. The number of segments “s” is 12. Two coil oppositely wound elements 26a and 26b are formed in overlapping relation on each of three coil element spaces, out of the six coil element spaces. Then, out of the twelve segments, six segments 27a are used for connection to form the series of coils.

As shown in the figure, one winding end of each of the coil elements 26a and 26b formed in overlapping relation, cross each other and are connected two adjacent segments 27a. The other winding ends of the other coil element 26a and 26b are led away from each other and connected to distant segments 27a. As in the foregoing embodiments having double windings, every fourth two segments 27a are connected to a coil element and every fourth two other interposing segments 27a are not connected to a coil segment.

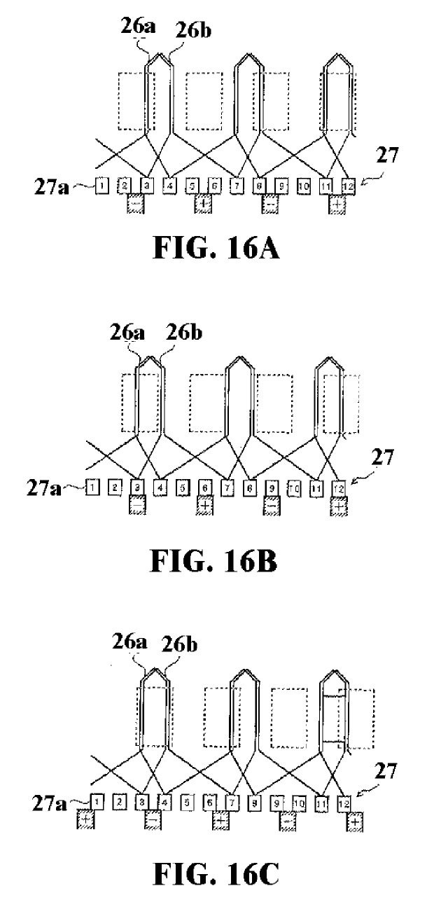

The current flow through the coil elements 26a and 26b during rotation through successive steps is shown in FIGS. 16A-16C similar to those of FIGS. 11A-11C where the brushes sequentially move relatively rightward in the drawing by half the segment, along with the rotation of the rotor. The arrows indicate the direction of energization from the brushes 31.

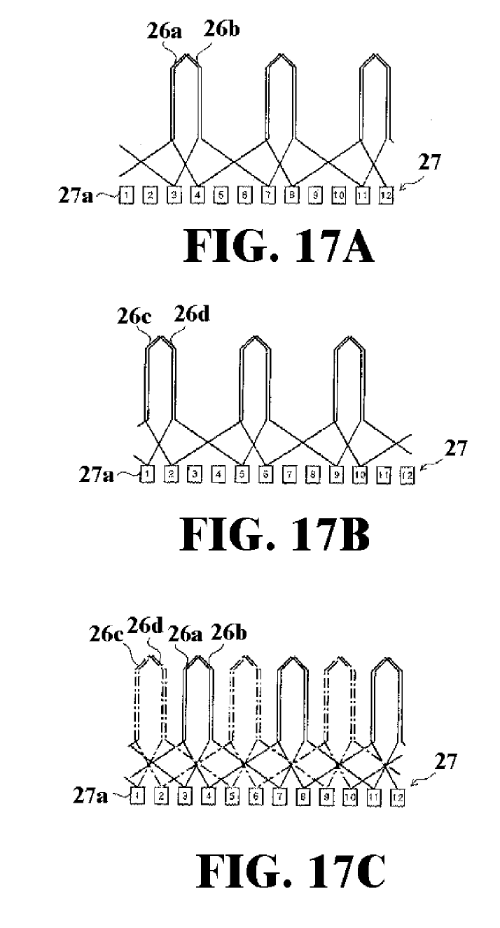

FIGS. 17A-17C shows the case where the three coil element spaces and six segments that are not used in the embodiment of FIG. 15 are used to form another series of coils in the same configuration as in FIG. 15. FIG. 17A is the same as FIG. 15, with two coil elements 26a and 26b formed in respective coil element spaces. FIG. 17B shows another series of coils in the same configuration as in FIG. 17A, formed in the other coil element spaces using the other segments. Two coil elements 26c and 26d formed in the respective coil element spaces are connected to form a series of coils. The components of FIGS. 17A and 17B are overlapped with each other as shown in FIG. 17C.

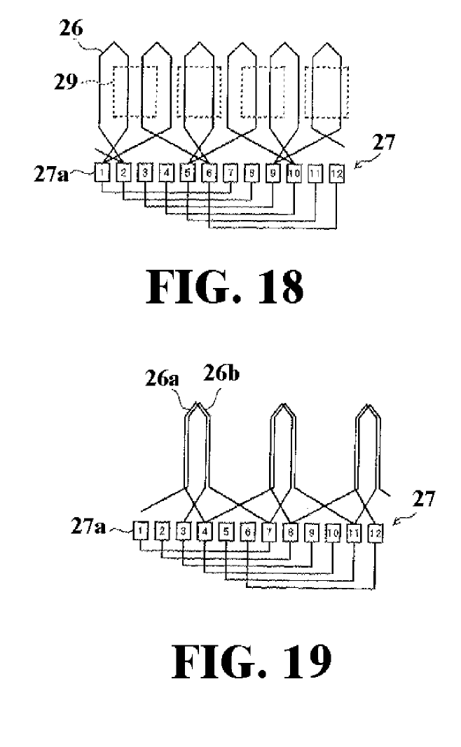

FIGS. 18, 19, 20A-20C and 21A-21C show the coil connection construction of four still other embodiments of the present invention. In these embodiments, the segments are mutually connected to reduce the number of brushes (to four or less).

FIG. 18 shows the case where each segment is connected to a segment located six segments away from it in the same coil winding structure as in the foregoing embodiment of FIG. 13.

FIG. 19 shows the case where each segment is connected to a segment located six segments away from it in the same coil winding structure as in the foregoing embodiment of FIG. 15.

In FIGS. 18 and 19 are shown examples with six coil element spaces and twelve segments. However, the present invention is not limited thereto, but applicable to cases where the number of coil element spaces is t and the number of segments is 2t, by connecting each segment to a segment located t segments away from it.

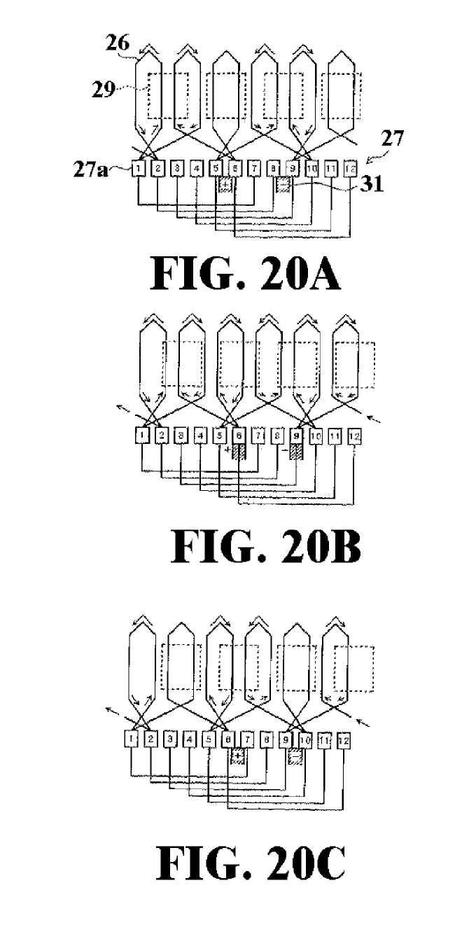

FIGS. 20A-20C are the counterparts of previously described embodiment of FIGS. 10A-10C but in the embodiment of FIG. 18 where the number of brushes is two, showing the states where the brushes sequentially move relatively rightward in the drawing by half the segment, along with the rotation of the rotor. Because of this similarity, further description of this embodiment is believed unnecessary to permit those skilled in the art to understand the construction and operation

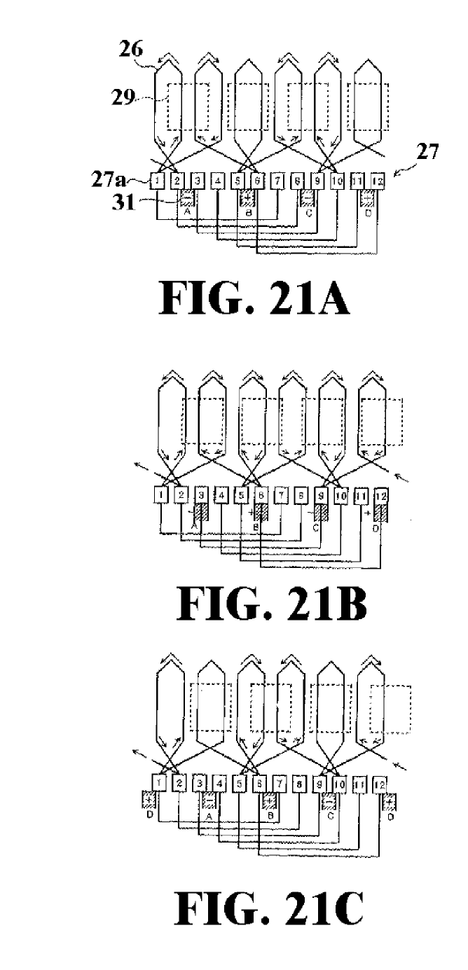

FIGS. 21A-21C are the counterparts of previously described embodiment of FIGS. 10A-10C but in the embodiment of FIG. 19 where the number of brushes is four, showing the states where the brushes sequentially move relatively rightward in the drawing by half the segment, along with the rotation of the rotor.

Thus it should be readily apparent from the foregoing descriptions that by mutually connecting the segments as described where the number of brushes is 2, 3, or 4, phase shift can be eliminated and the voltage can be increased without leakage. Also although the present invention is applicable to a flat motor with brushes for installation in a small space, such as a radiator fan for an automobile. Of course those skilled in the art will readily understand that the described embodiments are only exemplary of forms that the invention may take and that various changes and modifications may be made without departing from the spirit and scope of the invention, as defined by the appended claims.

What is claimed is:

1. A flat, brush type electrical machine comprising a plurality of flat coil elements disposed between a plurality of facing, circumferentially spaced permanent magnets, said coil elements having generally trapezoidal shape with the adjacent edges thereof closely spaced without overlapping each other, a commutator fixed relative to said coils and having segments to which respective coil winding ends are electrically connected, brushes in sliding contact with said segments for transferring electrical energy with said coils upon relative rotation between said coil elements and said permanent magnets.

2. A flat, brush type electrical machine as set forth in claim 1 wherein the axial thickness of the coil elements is generally tapered in a radial direction and the adjacent faces of the permanent magnets are tapered in a like manner to maintain a like gap between said coils and said permanent magnets in a radial direction.

3. A flat, brush type electrical machine as set forth in claim 2 wherein the thickness of the coil elements decreases in a radially outward direction.

4. A flat, brush type electrical machine as set forth in claim 2 wherein the variation in thickness of the coil elements is obtained by using a coil wire of round configuration having the same number of windings along the radial extent thereof with a greater number of overlapping coils on the thicker areas than on the thinner areas.

5. A flat, brush type electrical machine as set forth in claim 2 wherein the variation in thickness of the coil elements is obtained by using a flat coil wire of varying thickness along the radial extent thereof.

6. A flat, brush type electrical machine as set forth in claim 1 wherein the adjacent edges of the coil windings extend radially.

7. A flat, brush type electrical machine as set forth in claim 1 wherein the coil windings are connected to the commutator segments in such a way so that there are always two air gaps between connected segments at all times during relative rotation to avoid voltage loss.

8. A flat, brush type electrical machine as set forth in claim 7 wherein every fourth two commutator segments are connected to a coil winding and every fourth two other interposing commutator segments are not connected to coil and said coil windings and said commutator segments are connected such that adjacent coil windings are energized in opposite directions and the winding ends of coil element cross each other, cross one winding end of an adjacent coil winding and are connected to a commutator segment.

9. A flat, brush type electrical machine as set forth in claim 8 wherein the axial thickness of the coil elements is generally tapered in a radial direction and the adjacent faces of the permanent magnets are tapered in a like manner to maintain a like gap between said coils and said permanent magnets in a radial direction.

10. A flat, brush type electrical machine as set forth in claim 9 wherein the thickness of the coil elements decreases in a radially outward direction.

11. A flat, brush type electrical machine as set forth in claim 9 wherein the variation in thickness of the coil elements is obtained by using a coil wire of round configuration having the same number of windings along the radial extent thereof with a greater number of overlapping coils on the thicker areas than on the thinner areas.

12. A flat, brush type electrical machine as set forth in claim 9 wherein the variation in thickness of the coil elements is obtained by using a flat coil wire of varying thickness along the radial extent thereof.

13. A flat, brush type electrical machine as set forth in claim 9 wherein the adjacent edges of the coil windings extend radially.
